(19) United States
(12) Patent Application Publication
(10) Pub. No.: US 2014/0250161 A1
(43) Pub. Date: Sep. 4, 2014

(54) FUNCTION APPROXIMATION BASED ON STATISTICAL PROPERTIES

(71) Applicant: Ping Tak Peter Tang, Edison, NJ (US)

(72) Inventor: Ping Tak Peter Tang, Edison, NJ (US)

(21) Appl. No.: 13/997,644

(22) PCT Filed: Mar. 28, 2012
(86) PCT No.: PCT/US12/31041

§ 371 Date: Jun. 24, 2013

(51) Int. Cl. G06F 1/02

(52) U.S. Cl. CPC G06F 1/02
USPC 708/270

(57) ABSTRACT

Embodiments of techniques and systems for approximating a function are described. In embodiments, a computing device may receive one or more statistical properties associated with application of an approximation function of a function over a target domain. The computing device may formulate one or more constraints on one or more parameters of a functional form of the approximation function, based at least in part on the one or more statistical properties. The computing device may then determine the one or more parameters subject to the constraints and out put results of the determination. In embodiments, the one or more parameters may be determined through application of an optimization procedure. Other embodiments, may be described and claimed.

### FIELD

Embodiments of the present invention relate generally to the technical field of data processing, and more particularly, to function approximation based on statistical constraints.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Many applications of mathematical functions, such as scientific applications, utilize approximation functions. An approximation process may be performed to determine such an approximation function. For example, when a function (such as cos, sin, an exponential function, etc.) is needed for an application, an approximation function, such as a polynomial, may be chosen to approximate the function. The approximation function typically has a functional form. For example, a polynomial may have the form of 1+c₁x+c₂x² . . . +cₙxⁿ. The length of the polynomial (i.e. the number of terms) may depend on the precision desired for the approximation. For a particular approximation function, its parameters (e.g., polynomial coefficients in the case of a polynomial) may be found by determining the parameters that provide a desired precision of approximating the original function. For example, a minimax approximation process may be applied to determine a set of parameters for an approximation function that provide, overall, the lowest error, where error is defined as the largest deviation between the original function and the approximation function.

However, current function approximation procedures may not necessarily be the most suitable to a particular application. If an approximation function is computed in an over-precise manner, where a lower-precision approximation might do for a particular application, use of the higher-precision function can waste computational cycles unnecessarily. Further, many function approximation procedures may apply only general approximation techniques, even when approximating functions for particular scientific applications with particular needs. As such, these techniques may not best capture actual scientific needs of a particular application.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example statistical-property-based function approximation system, in accordance with various embodiments.

FIG. 2 illustrates an example statistical-property-based function approximation process, in accordance with various embodiments.

FIG. 3 illustrates an example function application description receipt process, in accordance with various embodiments.

FIG. 4 illustrates an example function approximation process, in accordance with various embodiments.

FIG. 5 illustrates an example computing environment, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (“ASIC”), an electronic circuit, a processor (shared, dedicated, or group) and/or memory (shared, dedicated, or group) that execute one or more software or firmware programs, a combinational logic circuit, and/or other suitable components that provide the described functionality.

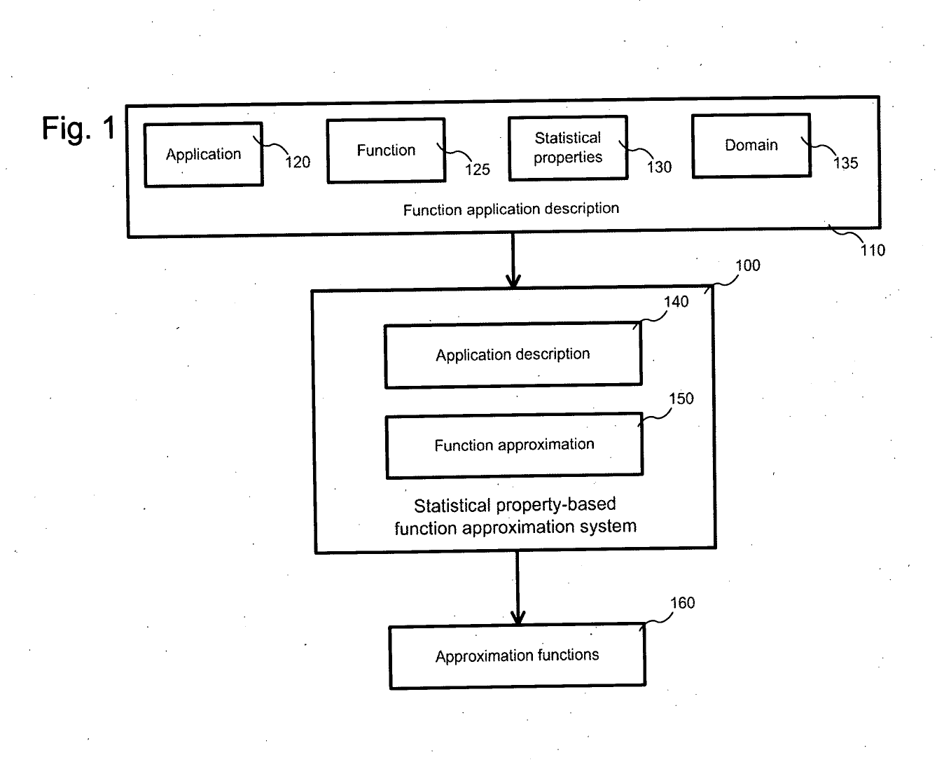

Referring now to FIG. 1, a statistical-property-based function approximation system 100 is illustrated. In various embodiments, the statistical-property-basedstatistical-property-based function approximation system 100 may operate to determine approximation functions for functions being used in applications, such as scientific applications. In various embodiments, the statistical-property-based function approximation system 100 may determine an approximation function for a function based in part on statistical properties associated with an application of the approximation function over a target domain; examples of these statistical properties are described herein. In embodiments, by determining the function approximation based on such statistical properties, the statistical-property-based function approximation system 100 may determine approximation functions to a desired precision with greater efficiency than other function approximation schemes. Additionally, by utilizing such statistical properties, the determined approximation function may be better tailored to a particular scientific application than they would be as determined by other techniques.

As illustrated in FIG. 1, in various embodiments the statistical-property-based function approximation system 100 may receive a function application description 110 describing an application for which a function approximation is desired. In various embodiments, as described herein, the statistical-property-based function approximation system 100 may use this function application description 110 to produce one or more approximation functions 160. In various embodiments, as described herein, the approximation functions 160 may be based, at least in part, on statistical properties of an application of the approximation function over a target domain.

In various embodiments, as described herein, the function application description 110 may include information that may be used for the statistical-property-based function approximation system 100 to determine a function approximation based on the above described statistical properties. Thus, in one embodiment, the function approximation description 110 may include a description of an application 120. In various embodiments, the description of the application 120 may include one or more of: description of a scientific application, a description of a data which may be utilized in a calculation for the application, types of result data created by the application, and other information.

The function approximation description 110 may also include a description of a function 125 to be approximated for the application. In various embodiments, the description of the function 125 may include a description of an implementation of the function; that implementation itself may include one or more functions. Thus, in some embodiments, the description of the function 125 may include more than one function. Further, in various embodiments, the description of the function 125 may include a description of a functional form for the approximation function to be determined by the statistical-property-based function approximation system 100.

The function approximation description 110 may also include a description of statistical properties 130. In various embodiments, as described herein, the description of the statistical properties 130 may include descriptions of one or more statistical properties that are based on a particular application of the approximation function over a target domain. In other embodiments, the description of the statistical properties 130 may include statistical properties that are based, at least in part, on the functional form of the approximation function desired, such as that described by the description of the function 125. In some embodiments, the description of the statistical properties 130 may include description of statistical properties of a error properties for the functional form of the approximation function. For example, in some embodiments, the approximation function will not necessarily always provide identical results as it is approximating the original function; thus, if the amount of error can be determined, the description of statistical properties 130 may describe particular properties of the approximation error. Further, in various embodiments, the description of the statistical properties 130 may describe one or more specific statistical moments of the approximation of the error should be a prescribed value. Thus, in one example, the description of statistical properties 130 may describe that an average of the approximation error over a domain (e.g., the first moment) should be zero (or close to zero). In alternative embodiments, the second moment, or other, higher-order moments may be used. In other embodiments, other statistical properties may be used.

The function approximation description 110 may also include a description of a domain 135 within which the approximation function is to be applied. In various embodiments, the description of the domain 135 may include a description of a range of values over which approximation function is to apply. In various embodiments, the description of the domain 135 may be based, at least in part, on the description of the application 120.

FIG. 1 also illustrates that the statistical-property-based function approximation system 100 may include one or more modules which perform function approximation operations, as described herein. For example, the statistical-property-based function approximation system 100 may include an application description module 140. In various embodiments, the application description module 140 may be configured to receive function application description information, such as in the form of the function application description 110. In some embodiments, the application description module 140 may also provide one or more interfaces to facilitate a user in entering or otherwise providing function application description information.

In various embodiments, the statistical-property-based function approximation system 100 may include a function approximation module 150. In various embodiments, the function approximation module 150 may be configured to perform function approximation based, at least in part, on one or more constraints. These constraints may be formulated by the function approximation module 150, in various embodiments, on statistical properties received by the application description module 140. The statistical properties, as described earlier, may be statistical properties associated with an application of the approximation function over a domain. In various embodiments, the function approximation module 150 may perform function approximation using an optimization approximation procedure, but subject to constraints. In various embodiments, the optimization approximation procedure may include minimax approximation, but subject to constraints, as mentioned above. In alternative embodiments, the optimization approximation procedure may include alternative techniques, such as, but not limited to, least squares approximation, L1 minimization, and/or weighted minimization. In various embodiments, the function approximation module 150 may formulate the constraints based on error properties for the approximation function being determined. In various embodiments, the constraints may include constraints that are able to be accommodated by a particular optimization approximation procedure being used.

In embodiments, the statistical-property-based function approximation system 100 may output one or more determined approximation functions 160. The output of an approximation function 160 may include, in various embodiments, parameters of the functional form of the approximation function. For example, the approximation results may include one or more coefficients for a polynomial functional form of an approximation function. In yet other embodiments, the statistical-property-based function approximation system 100 my output approximation values resulting from application of a determined approximation function for various input data of the target domain along with, or in lieu of, an approximation function.

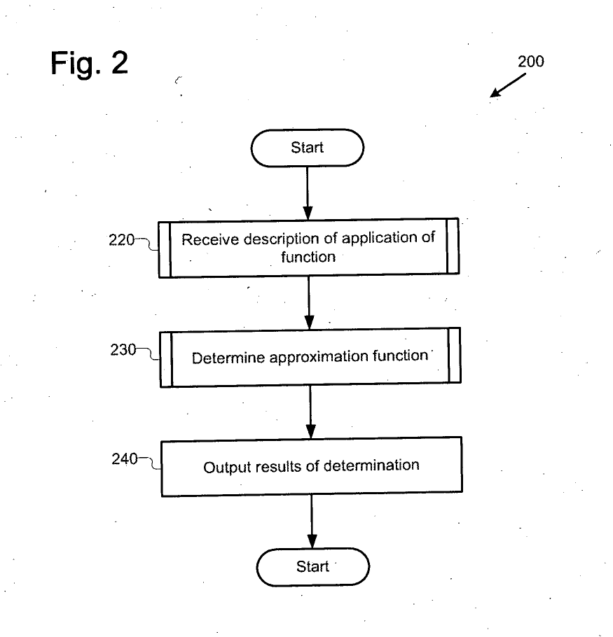

FIG. 2 illustrates an example statistical-property-based function approximation process 200. In various embodiments, process 200 may be performed by the statistical-property-based function approximation system 100. The process may begin at operation 220, where the statistical-property-based function approximation system 100 may receive a description of an application of a function for which an approximation function for application over a domain is desired, such as, for example, the function application description 110. Particular embodiments of operation 220 are described below.

Next, at operation 230, the statistical-property-based function approximation system 100 may determine an approximation function based on the received application description 110. Particular embodiments of operation 220 are described below. Next, at operation 240, results of the determination may be output. The process may then end.

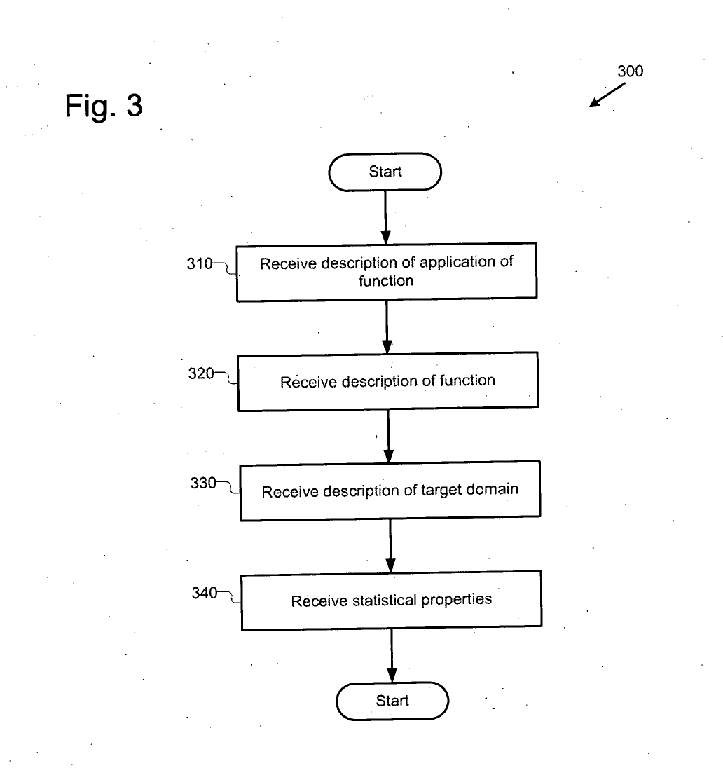

FIG. 3 illustrates an example function application description receipt process 300. In various embodiments, process 300 may be performed by the application description module 140 of the statistical-property-based function approximation system 100 as an implementation of operation 210 of process 200. While process 300 is illustrated as multiple separate operations, in some embodiments, the operations of process 300 may be performed through receipt of an function application description 110.

The process may begin at operation 310, where the application description module 140 may receive a description of an application of a function to a domain for which the function needs to be approximated, such as description of the application 120. Particular examples of a description of an application are described above, and further examples follow. Next, at operation 320, the application description module 140 may receive a description of a function for which a function needs to be approximated, such as description of the function 125. Particular examples of a description of the function are described above, and further examples follow.

Next, at operation 330, the application description module 140 may receive a description of statistical properties associated with the application of an approximation function over a domain, such as description of the statistical properties 130. Particular examples of a description of the statistical properties are described above, and further examples follow. Next, at operation 340, the application description module 140 may receive a description of a domain for which the determined approximation function is to be applied, such as description of the domain 135. Particular examples of a description of the domain are described above, and further examples follow.

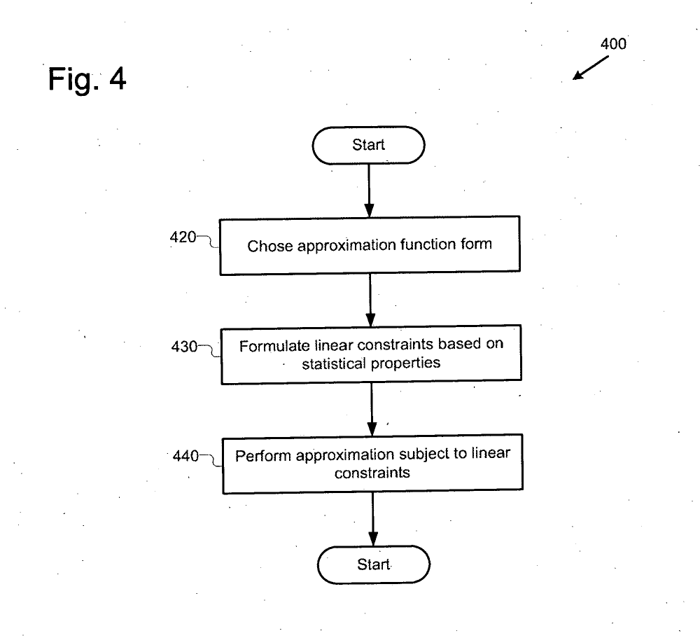

FIG. 4 illustrates an example function approximation process 400. In various embodiments, process 400 may be performed by the function approximation module 150 as an implementation of operation 220 of process 200 to determine an approximation function based on the information received in the function application description 110. The process may begin at operation 420, where the function approximation module 150 may choose a functional form for the approximation function. In some embodiments, this functional form may include a polynomial form; in other embodiments, other functional forms may be chosen. In some embodiments, the functional form may be based at least in part on the description of the function 125 that was received in the function application description 110. In some embodiments, the functional form for the approximation may be chosen without reliance on a preferred functional form from the description of the function 125.

Next, at operation 430, the function approximation module 150 may formulate one or more constraints for the parameters of the approximation function based on the previously-received statistical properties associated with the approximation function application over a target domain. In some embodiments, the constraints may be linear constraints; in other embodiments, other constraints may be utilized. Particular examples of constraints formulated from such statistical properties are discussed below. Next, at operation 440, the function approximation module 150 may perform approximation of the function described in the description of the function 125, subject to the formulated constraints. In various embodiments, this approximation may utilize one or more optimization approximation techniques, such as, for example a minimax approximation, but subject to the previously-formulated constraints. As discussed above, in alternative embodiments, the function approximation module 150 may perform approximation of the function using alternative techniques, such as, but not limited to, least squares approximation, L1 minimization, and/or weighted minimization, but subject to the previously-formulated constraints. In various embodiments, the constraints may include constraints that are able to be accommodated by a particular optimization procedure being used. In some embodiments, the function approximation performed at operation 440 may result in the determination of one or more parameters of the functional form for the approximation function. These parameters may then be output, such as at operation 240 of process 200.

In order to better illustrate embodiments of the statistical-property-based function approximation system 100, as well as embodiments of the function approximation techniques described herein, two function approximation examples will be introduced. These examples provided solely for the purpose of illustration and are not intended to imply any limitation on any embodiments described herein.

In a first example, function approximation may be desired for image reconstruction in synthetic aperture radar signal via backprojection. Thus, in embodiments, the description of application 120 may include a description of the image reconstruction application. In such an application, a core computation may be the summation:

Σₗwₗe^{iθ}^{ₗ}

where wₗ is radar signal data and e^{iθis l} is a function that may be approximated. Thus, the description of the function 125 may describe e^{iθ}^{ₗ}. Further, however, the e^{iθ}^{ₗ} term may be implemented as a function involving cos and sin functions, as may be understood. Thus, in some embodiments, the description of the function 125 may include a description that cos and sin are desired to be approximated. The sin and cos functions may be approximated by approximation functions with polynomial functional forms. Thus, in some embodiments, the description of the function 125 may describe that sin and cos are to be approximated using polynomial functional forms: Those forms will be described at p(x) and q(x), respectively. The target domain over which the approximation function to be applied may be described with the description of the domain as [0,π].

As discussed above, in various embodiments, the description of statistical properties 130 may be based on one or more error properties, for the approximation function. In the present example, the error properties may be represented as:

Σₗwₗ(e^{iθ}^{ₗ}−(p(x)+iq(x)))

this, in turn, means that there are error terms of the form cos(x)(cos(x)−p(x)) and sin(x)(sin(x)−q(x)). This means, if the description of the statistical properties 130 describes that error should be minimized over the domain [0,π], then the approximation module 150 may determine that the polynomials p(x) and q(x) should have the respective properties:

∫₀^{π} cos(x)(cos(x)−p(x))=0

and

∫₀^{π} sin(x)(sin(x)−q(x))=0.

In various embodiments, these forms may be used due to the form of wₗ particular to radar-signal processing.

These two constraints may then, in turn, be modified into linear constraints for the determination of coefficients for the polynomials p(x) and q(x), as may be understood. Then, through application of an approximation process, such as a minimax approximation, subject to these formulated linear constraints, coefficients for the polynomials p(x) and q(x) may be determined, and then output.

In a second example, in the field of molecular dynamic simulation, it may be desired to simulate the motion of atoms (or other particles) in a chemical system via Newtonian mechanics. The simulation may proceed time-step by time-step, in intervals typically on the order of 2 to 3 femtoseconds (10⁻¹⁵ seconds). In a chemical system with N particles, At every time step, each particle pᵢ may be located at a position in 3-dimensional space. For each particle pᵢ, it may be desirable to compute the force exerted on it by all the other particles pⱼ. In many applications, the force may be modeled by a function g(r) with the force between particle pᵢ and pⱼ represented by g(rᵢⱼ) where rᵢⱼ is the distance between the two particles. The total force on particle pᵢ may then be given by:

$${F}_{i} = {\sum }_{j \neq i} g ( {r}_{ij} ) .$$

After the force on each particle is computed, the particles may then be allowed to move (that is, their positions may change) to their projected positions in the next time step.

In various implementations of this application, the force function g(r) can be quite complicated and expensive to evaluate, in terms of computing power. For example, the function may take the form:

g(r)=(Kᵢ exp)−r²)r+K₂ erfc(r))/r³

where K₁ and K₂ are constants and erfc(r) represents the complementary error function, as will be understood. In practice, molecular dynamics simulation code often uses a polynomial approximation function p(r) for g(r) to speed up the simulation process. This polynomial may be obtained beforehand and used for all computations of g(r) during the simulation. Thus, in embodiments, the description of the function 125 may describe that g(r) is to be approximated with a polynomial p(r).

However, to preserve thermal dynamic properties of the system under simulation, it may be important that on the average, the error property tends to zero. This is because, if the error property tends to zero, the system will exhibit less bias. Otherwise, if the computed force on a particle is, on average, pulling the particle in a particular direction, the resulting simulation may lose fidelity. Hence, a statistical property of the application of the approximation function may be that for any fixed particle pᵢ:

Average(g(rᵢⱼ)−p(rᵢⱼ))=0

as closely as possible. This average may be taken over all the particles in the system. This property may be described in the description of statistical properties 130.

When formulating the linear constraints from this statistical property, the function approximation module may make use of a probability distribution of the distances between particles. For example, in some chemical systems, particles may be distributed uniformly in volume. That is, there may be more or less a fixed number of particles per fixed amount of volume, regardless of where the volume is located at. Using this assumption, the distribution of number of particles in terms of distance r is of the form r². This is proportional to the surface area of a sphere of radius r. Consequently, the function approximation module 150 may determine that the polynomial p(x) should satisfy the constraint:

∫_{min r}^{max r}(g(r)−p(r))r² dr=0

As with the integrals above, this integral may be converted to a linear constraint on the coefficients of p(r). The function approximation module 150 may then perform function approximation for g(r) subject to this linear constraint.

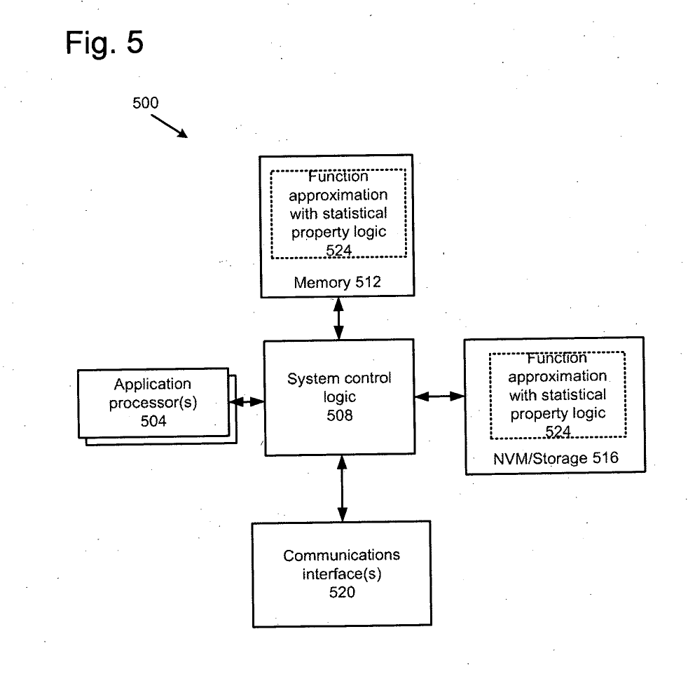

The techniques and apparatuses described herein may be implemented into a system using suitable hardware and/or software to configure as desired. FIG. 5 illustrates, for one embodiment, an example system control logic 508 coupled to at least one of the processor(s) 504, system memory 512 coupled to system control logic 508, non-volatile memory (NVM)/storage 516 coupled to system control logic 508, and one or more communications interface(s) 520 coupled to system control logic 508. In various embodiments, the one or more processors 504 may be a processor core.

System control logic 508 for one embodiment may include any suitable interface controllers to provide for any suitable interface to at least one of the processor(s) 504 and/or to any suitable device or component in communication with system control logic 508.

System control logic 508 for one embodiment may include one or more memory controller(s) to provide an interface to system memory 512. System memory 512 may be used to load and store data and/or instructions, for example, for system 500. In one embodiment, system memory 512 may include any suitable volatile memory, such as suitable dynamic random access memory (“DRAM”), for example.

System control logic 508, in one embodiment, may include one or more input/output (“I/O”) controller(s) to provide an interface to NVM/storage 516 and communications interface(s) 520.

NVM/storage 516 may be used to store data and/or instructions, for example. NVM/storage 516 may include any suitable non-volatile memory, such as flash memory, for example, and/or may include any suitable non-volatile storage device(s), such as one or more hard disk drive(s) (“HDD(s)”), one or more solid-state drive(s), one or more compact disc (“CD”) drive(s), and/or one or more digital versatile disc (“DVD”) drive(s), for example.

The NVM/storage 516 may include a storage resource physically part of a device on which the system 500 is installed or it may be accessible by, but not necessarily a part of, the device. For example, the NVM/storage 516 may be accessed over a network via the communications interface(s) 520.

System memory 512 and NVM/storage 516 may include, in particular, temporal and persistent copies of function approximation with statistical property logic 524. The function approximation with statistical property logic 524 may include instructions that when executed by at least one of the processor(s) 504 result in the system 500 practicing one or more of the techniques described above. In some embodiments, the function approximation with statistical property logic 524 may additionally/alternatively be located in the system control logic 508.

Communications interface(s) 520 may provide an interface for system 500 to communicate over one or more network(s) and/or with any other suitable device. Communications interface(s) 520 may include any suitable hardware and/or firmware, such as a network adapter, one or more antennas, a wireless interface, and so forth. In various embodiments, communication interface(s) 520 may include an interface 521 for system 500 to use NFC, optical communications (e.g., barcodes), BlueTooth or other similar technologies to communicate directly (e.g., without an intermediary) with another device.

For one embodiment, at least one of the processor(s) 504 may be packaged together with system control logic 508 and/or function approximation with statistical property logic 524. For one embodiment, at least one of the processor(s) 504 may be packaged together with system control logic 508 and/or function approximation with statistical property logic 524 to form a System in Package (“SiP”). For one embodiment, at least one of the processor(s) 504 may be integrated on the same die with system control logic 508 and/or function approximation with statistical property logic 524. For one embodiment, at least one of the processor(s) 504 may be integrated on the same die with system control logic 508 and/or function approximation with statistical property logic 524 to form a System on Chip (“SoC”).

The following paragraphs describe examples of various embodiments. In various embodiments, an apparatus for approximating a function may include one or more computer processors. The apparatus may also include an application definition module which may be configured to be operated by the one or more computer processors to receive one or more statistical properties associated with application of an approximation function of the function over a target domain, wherein the approximation function has a functional form with one or more parameters. The apparatus may also include an approximation module. The approximation module may be configured to be operated by the one or more computer processors to formulate one or more constraints on the one or more parameters based at least in part on the one or more statistical properties. The approximation module may also be configured to be operated by the one or more computer processors to determine the one or more parameters subject to the constraints. The approximation module may also be configured to be operated by the one or more computer processors to output results of the determination.

In various embodiments, the application definition module may be further configured to be operated by the one or more computer processors to receive one or more statistical properties through receipt of one or more of a description of the first functional form or the one or more parameters.

In various embodiments, the application definition module may be further configured to be operated by the one or more computer processors to receive one or more statistical properties through receipt of one or more error properties of the approximation function. In various embodiments, the error properties may include a second functional form. The approximation module may be configured to formulate the one or more constraints based at least in part on the second functional form of the error properties. In various embodiments, the statistical properties may include an error property having a first moment having a prescribed value over the target domain. In various embodiments, the statistical properties may include an error property having a higher-order moment having a prescribed value over the target domain.

In various embodiments, the approximation module may be further configured to be operated by the one or more computer processors to determine the one or more parameters through application of an optimization procedure. In various embodiments, the approximation module may be further configured to formulate the one or more constraints through formulation of one or more constraints that can be accommodated by the optimization procedure. In various embodiments, the application definition module may be further configured to be operated by the one or more computer processors to receive a description of the application of the function. In various embodiments, the description may describe an application of the function to a scientific computation requiring extended precision. In various embodiments, the application definition module may be further configured to receive an indication of the target domain.

Computer-readable media (including non-transitory computer-readable media), methods, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. One or more non-transitory computer-readable storage media having instructions embodied therein that are configured, in response to execution by a computing device, to cause the computing device to:
receive one or more statistical properties associated with application of an approximation function of a function over a target domain, wherein the approximation function has a first functional form with one or more parameters;
formulate one or more constraints on the one or more parameters based at least in part on the one or more statistical properties;
determine the one or more parameters subject to the constraints; and
output results of the determination.

2. The computer-readable media of claim 1, wherein receive one or more statistical properties comprises receive one or more statistical properties through receipt of one or more of a description of the first functional form or the one or more parameters.

3. The computer-readable media of claim 1, wherein receive one or more statistical properties comprises receive one or more statistical properties through receipt of one or more error properties of the approximation function.

4. The computer-readable media of claim 3, wherein the error properties comprise a second functional form and wherein the instructions are configured, in response to execution by the computing device, to formulate the one or more constraints based at least in part on the second functional form of the error properties.

5. The computer-readable media of claim 3, wherein the statistical properties comprise an error property having a first moment having a prescribed value over the target domain.

6. The computer-readable media of claim 3, wherein the statistical properties comprise an error property having a higher-order moment having a prescribed value over the target domain.

7. The computer-readable media of claim 1, wherein determine the one or more parameters comprises determine the one or more parameters through application of an optimization procedure.

8. The computer-readable media of claim 7, wherein formulate the one or more constraints comprises formulate the one or more constraints through formulation of one or more constraints that can be accommodated by the optimization procedure.

9. The computer-readable media of claim 8, wherein the instructions are further configured, in response to execution by the computing device, to cause the computing device to receive a description of the application of the function.

10. The computer-readable media of claim 9 wherein the description comprises a description of an application of the function to a scientific computation requiring extended precision.

11. The computer-readable media of claim 1, wherein the instructions are further configured to cause the computing device, in response to execution by a computing device, to receive an indication of the target domain.

12. An apparatus for approximating a function, the apparatus comprising:
one or more computer processors;
an application definition module configured to be operated by the one or more computer processors to receive one or more statistical properties associated with application of an approximation function of the function over a target domain, wherein the approximation function has a functional form with one or more parameters; and
an approximation module configured to be operated by the one or more computer processors to:
formulate one or more constraints on the one or more parameters based at least in part on the one or more statistical properties;
determine the one or more parameters subject to the constraints; and
output results of the determination.

13. The apparatus of claim 12, wherein the application definition module is further configured to be operated by the one or more computer processors to receive one or more statistical properties through receipt of one or more of a description of the first functional form or the one or more parameters.

14. The apparatus of claim 12, wherein the application definition module is further configured to be operated by the one or more computer processors to receive one or more statistical properties through receipt of one or more error properties of the approximation function.

15. The apparatus of claim 14, wherein the error properties comprise a second functional form and wherein the approximation module is configured to formulate the one or more constraints based at least in part on the second functional form of the error properties.

16. The apparatus of claim 14, wherein the statistical properties comprise an error property having a first moment having a prescribed value over the target domain.

17. The apparatus of claim 14, wherein the statistical properties comprise an error property having a higher-order moment having a prescribed value over the target domain.

18. The apparatus of claim 12, wherein the approximation module is further configured to determine the one or more parameters through application of an optimization procedure.

19. The apparatus of claim 18, wherein the approximation module is configured to formulate the one or more constraints through formulation of one or more constraints that can be accommodated by the optimization procedure.

20. The apparatus of claim 19, wherein the application definition module is further configured to be operated by the one or more computer processors to receive a description of the application of the function.

21. (canceled)

22. The apparatus of claim 12, wherein the application definition module is further configured to receive an indication of the target domain.

23. A computer-implemented method for approximating a function, the method comprising:
receiving, by a computing device, one or more statistical properties associated with application of an approximation function of the function over a target domain, wherein the approximation function has a first functional form with one or more parameters;
formulating, by the computing device, one or more constraints on the one or more parameters based at least in part on the one or more statistical properties;
determining, by the computing device, the one or more parameters subject to the constraints; and
outputting, by the computing device, results of the determination.

24. The method of claim 23, wherein receiving one or more statistical properties comprises receiving one or more of a description of the first functional form or the one or more parameters.

25. The method of claim 23, wherein receiving one or more statistical properties comprises receiving one or more error properties of the approximation function.

26. (canceled)

27. (canceled)

28. (canceled)

29. The method of claim 23, wherein determining the one or more parameters comprises performing an optimization procedure.

30. (canceled)

31. (canceled)

32. The method of claim 31, wherein the description describes an application of the function to a scientific computation requiring extended precision.

33. The method of claim 23, further comprising receiving, by the computing device, an indication of the target domain.
